(19) United States
(12) Patent Application Publication
(10) Pub. No.: US 2013/0298824 A1
(43) Pub. Date: Nov. 14, 2013

(54) BIKE LUBRICANT WIPE

(71) Applicant: Donato Polignone, Emeryville, CA (US)

(72) Inventor: Donato Polignone, Emeryville, CA (US)

(21) Appl. No.: 13/466,938

(22) Filed: May 8, 2012

(51) Int. Cl. B05C 11/10; C10M 131/00; B05C 11/00; C10M 131/10; C10M 129/04; C10M 131/02; C10M 139/04

(52) U.S. Cl. 118/270; 508/590; 508/207; 508/582; 508/110; 508/583; 118/264

(57) ABSTRACT

One example embodiment includes a lubricant for application on an external device. The lubricant includes a solvent cleaner. The lubricant also includes a lubricating agent.

### CROSS-REFERENCE TO RELATED APPLICATIONS

Not applicable.

### BACKGROUND OF THE INVENTION

Many moving parts require regular lubrication. A lubricant is a substance introduced to reduce friction between moving surfaces. This allows a greater portion of the input energy to be converted to output energy. In particular, it can ensure that parts are able to move past one another in a smooth manner, reducing the energy required to produce the movement.

However, over time lubricants begin to fail. This can occur because of a number of different factors. For example, the heat or mechanical stress caused by the movement, or simply the aging of the lubricant, can cause the lubricant to breakdown. I.e., on a molecular level, the lubricant can begin to degrade, reducing or destroying the effectiveness of the lubricant.

In addition, the lubricant can become dirty. For example, dust particles can be captured in the lubricant. As the dust particles buildup, they can reduce the lubricating properties of the lubricant. In addition, as the parts come in contact, minute wear can occur. These particles may be captured in the lubricant, reducing its effectiveness.

In general, when the lubricant becomes less effective it is either replaced or removed. I.e., the old lubricant may be partially or completely removed. New lubricant is then added. This presents a number of problems, however. First, if the lubricant has broken down or become dirty it may form a gummy layer which is difficult to remove. Often, the only way to remove the gummy layer is through scraping or otherwise physically removing the gummy layer.

Second, application of the new lubricant can lead to lubricant in other areas, leading to problems. For example, lubricant is often sprayed directly onto a bike chain. This results in lubricant on the chain; however, there is often over spray which results in lubricant on the pedals or other areas. This lubricant may then make the user's feet slip or cause other problems.

Accordingly there is a need in the art for a lubricant that removes old lubricant when applied. Additionally, there is a need for the lubricant to capable of begin applied directly to an area without getting on surrounding areas.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a lubricant for application on an external device. The lubricant includes a solvent cleaner. The lubricant also includes a lubricating agent.

Another example embodiment includes a system for applying a lubricant to an external device. The system includes a wipe. The system also includes a lubricant. The lubricant is embedded in the wipe. The lubricant includes a solvent cleaner. The lubricant also includes a lubricating agent.

Another example embodiment includes a system for applying a lubricant to an external device. The system includes a wipe. The system also includes a container. The wipe is located within the container. The container includes an opening, wherein the opening is configured to allow a user to access the wipe if desired. The container is configured to prevent air exchange between the interior of the container and the exterior of the container if the opening is closed. The system further includes a lubricant. The lubricant is embedded in the wipe. The lubricant includes a solvent cleaner, wherein the solvent cleaner vaporizes completely. The lubricant also includes a lubricating agent. The lubricating agent either does not vaporize or vaporizes at a low rate.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system in need of lubrication;

FIG. 2 is a flowchart illustrating an example of a method for manufacturing a lubricant; and

FIG. 3 illustrates an example of a lubricant applicator.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

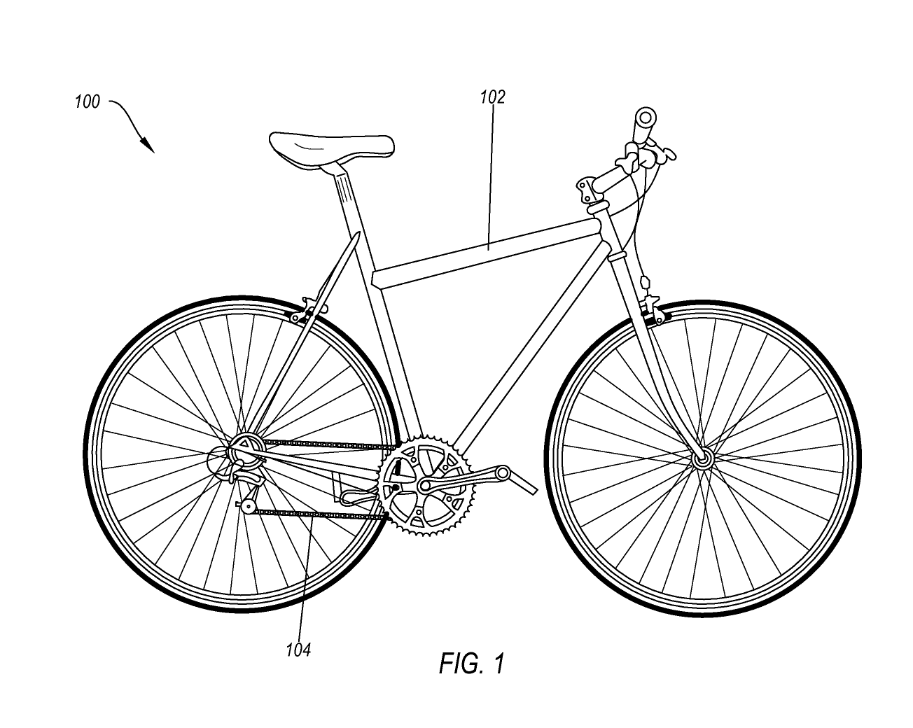

FIG. 1 illustrates an example of a system 100 in need of lubrication. In at least one implementation, the system 100 can include any system which has one or more parts which must be lubricated on a regular basis. For example, the system 100 can include a chain, cable, gear or other mechanism which a user may lubricate. In particular, the system 100 can include a mechanism which the user can access in order to add a lubricant.

FIG. 1 shows that the system 100 can include a bike 102. In at least one implementation, a bike, often called a bicycle (and sometimes referred to as a “pushbike”, “pedal bike”, “pedal cycle”, or “cycle”), is a human-powered, pedal-driven, single-track vehicle, having two wheels attached to a frame, one behind the other. One of skill in the art will appreciate that a bike is an example of a system 100 which requires lubrication and is not limiting herein unless otherwise specified in the claims.

FIG. 1 shows that the system 100 can also include a chain 104. In at least one implementation, the chain 104 is configured to transfer motion of the pedals to motion of the wheels. Motion transfer may be accomplished through one or more gears. One of skill in the art will appreciate that the chain 104 requires regular lubrication. Lubrication allows the chain to move more smoothly through the gears, transferring more of the user's movement to movement of the wheels.

### Example of a Lubricant

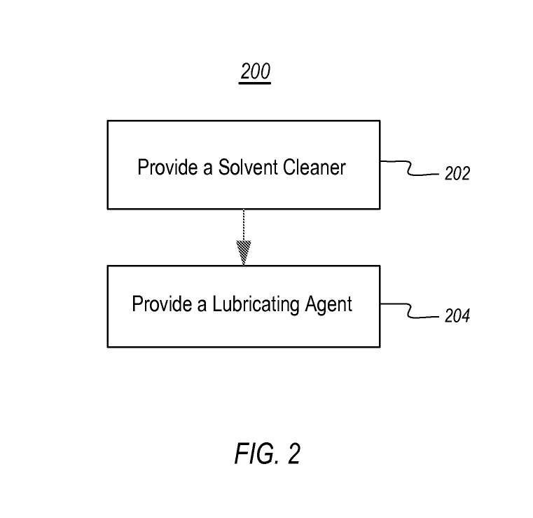

FIG. 2 is a flowchart illustrating an example of a method 200 for manufacturing a lubricant. In at least one implementation, the lubricant can be used for lubricating a chain, cable, pulley, gears or any other device. Therefore, the method 200 will be described, exemplarily, with reference to the device 100 of FIG. 1. Nevertheless, one of skill in the art can appreciate that the method 200 can be used to produce a lubricant suitable for use in devices other than the device 100 of FIG. 1.

FIG. 2 shows that the method 200 can include providing 202 a solvent cleaner. In at least one implementation, the solvent cleaner can provide a base for the lubricant. I.e., the solvent cleaner can allow the other components of the lubricant to fully dissolve and/or mix completely. The solvent cleaner can be highly volatile, leaving behind only the other components of the lubricant after application. Additionally or alternatively, the solvent cleaner can clean debris from the area to be lubricated. I.e., the solvent cleaner can remove old lubricant, dust, dirt or other debris.

One example of a solvent cleaner includes hydrofluorocarbons (HFCs). HFCs include hydrocarbons in which one or more of the hydrogen atoms has been replaced with a fluorine atom. The carbon-fluorine bond is one of the strongest in organic chemistry and it is relatively short. Its properties reflect in part the high electronegativity of fluorine. As a result, the physical and chemical properties of HFCs can be distinctive in comparison to their related hydrocarbon. Examples of acceptable HFCs for use in a cleanroom lubricant include HFC-43-10 (also known as Vertrel XF—made by DuPont) and HFC-365mfc. HFC-43-10 includes 1,1,1,2,2,3,4,5,5,5-Decafluoropentane (C₅H₂F₁₀). HFC-365mfc includes 1,1,1,3,3-pentafluorobutane (C₄F₅H₅).

Another example of a solvent cleaner includes perfluorocarbons (PFCs). PFCs, sometimes referred to as fluorocarbons, are organofluorine compounds that contain carbon and fluorine. I.e., they are hydrocarbons in which all of the hydrogen atoms have been replaced with fluorine atoms. In general, PFCs have chemical inertness and thermal stability because of the strength of the carbon-fluorine bond and the shielding effect of the fluorine atoms. In addition, the electronegativity of fluorine reduces the polarizability of the electron clouds. This results in reduced van der Waals forces between PFCs. I.e., PFCs tend to be highly volatile. Examples of acceptable PFCs include perfluoropentane (C₅F₁₂), perfluorohexane (C₆F₁₄), perfluoroheptane (C₇F₁₆), perfluorooctane (C₈F₁₈), perfluorohexene (C₆F₁₂), perfluoruoctene (C₈F₁₆), isomers of the chemical formula C₅F₁₁NO (e.g., 2,2,3,3,5,5,6,6-octafluoro-4-(trifluoromethyl)morpholine, (1Z)-2,2,3,3,4,4,4-Heptafluoro-N-(trifluoromethoxy)butanimidoyl fluoride, 2,3,3,3-Tetrafluoro-N,N-bis(trifluoromethyl)alanyl fluoride, 3-[Bis(trifluoromethyl)amino]-2,2,3,3-tetrafluoropropanoyl fluoride or 3,3,4,4-Tetrafluoro-2-(heptafluoropropyl)-1,2-oxazetidine, 3,3,4,4,5,5,6,6-Octafluoro-2-(trifluoromethyl)-1,2-oxazinane), isomers of the chemical formula C₆F₁₃NO (e,g., 2,2,3,3,5,5,6,6-Octafluoro-4-(pentafluoroethyl)morpholine, (1Z)-2,2,3,3,3-Pentafluoro-N-(heptafluoropropoxy)propanimidoyl fluoride, Pentafluoroethyl(heptafluoropropyl)carbonofluoridimidate, 3-Fluoro-2-(heptafluoropropyl)-3-(pentafluoroethyl)oxaziridine, (2R,6S)-2,3,3,4,5,5,6-Heptafluoro-2,6-bis(trifluoromethyl)morpholine or 1,1,1,2,2,3,3,5,5,5-Decafluoro-4-nitroso-4-(trifluoromethyl)pentane) and isomers of the chemical formula C₇F₁₅NO (e.g., Pentadecafluoroheptanamide or (1Z)-2,2,3,3,4,4,4-Heptafluoro-N-[(1,1,1,2,3,3,3-heptafluoro-2-propanyl)oxy]butanimidoyl fluoride).

Another example of a solvent cleaner includes hydrofluoroethers (HFEs). HFEs are HFCs which include an ether group—an oxygen atom connected to two alkyl or aryl groups. I.e. HFEs are two or more hydrocarbons connected to one another by an oxygen atom in which one or more of the hydrogen atoms have been replaced by a fluorine atom. Examples of acceptable HFEs include HFE-7000, HFE-7100 and HFE-7200 (made by 3M). HFE-7000 includes 1,1,1,2,2,3,3-Heptafluoro-3-methoxypropane (C₄H₃F₇O—aka methyl perfluoropropyl ether). HFE-7100 includes a mixture of 1,1,1,2,2,3,3,4,4-nonafluoro-4-methoxybutane (C₅H₃F₉O—aka methyl nonafluorobutyl ether) and 2-(difluoromethoxymethyl)-1,1,1,2,3,3,3-heptafluoropropane (C₅H₃F₉O—aka methyl nonafluoroisobutyl ether). HFE-7200 includes a mixture of 1-ethoxy-1,1,2,2,3,3,4,4,4-nonafluoro-butane (C₆H₅F₉O—aka ethyl nonafluorobutyl ether) and 2-(ethoxydifluoromethyl)-1,1,1,2,3,3,3-heptafluoro-propane (C₆H₅F₉O—aka ethyl nonafluoroisobutyl ether).

Another example of a solvent cleaner includes volatile methyl siloxanes. A methyl siloxane is any chemical compound composed of units of the form (CH₃)₂SiO. Methyl siloxanes can have branched or unbranched backbones consisting of alternating silicon and oxygen atoms (e.g., —Si—O—Si—O—), with side chains methyl groups attached to the silicon atoms. Examples of methyl siloxanes include hexamethyldisiloxane, octamethyltrisiloxane, decamethyltetrasiloxane, polydimethylsiloxane, hexamethylcyclotrisiloxane, octamethylcyclotetrasiloxane, decamethylcyclopentasiloxane and dodecamethylcyclohexasiloxane.

Another example of a solvent cleaner includes a super critical fluid. A supercritical fluid is any substance at a temperature and pressure above its critical point, where distinct liquid and gas phases do not exist. It can effuse through solids like a gas, and dissolve materials like a liquid. In addition, close to the critical point, small changes in pressure or temperature result in large changes in density.

Another example of a solvent cleaner includes common solvents such as kerosene, mineral spirits, alcohols, terpenes, C5-C20 petroleum hydrocarbons, oxygenated organic solvents such as ketones, esters, ethers. Another example of a solvent cleaner includes vanishing oils. In at least one implementation, vanishing oils include any solvent that completely disappears after it has done its job. I.e., vanishing oils include solvents with a high volatility rate, such that they completely evaporate shortly after application.

Another example of a solvent cleaner includes HCFC-225ca and HCFC-225cb. HCFC-225ca and HCFC-225cb are isomers of dichloropentafluoropropane (C₃HCl₂F₅). Another example of a solvent cleaner includes heptafluorocyclopentane (C₅H₃F₇). Another example of a solvent cleaner includes n-Propyl bromide. n-Propyl bromide (C₃H₇Br aka 1-bromopropane, 1-propyl bromide or bromomethylethane) is a colorless to off-white, non-flammable chemical compound.

Another example of a solvent cleaner includes a chlorinated hydrocarbon. Examples of acceptable chlorinated hydrocarbons include trichloroethylene (C₂HCl₃ aka trichloroethene), perchloroethylene (C₂Cl₄ aka tetrachloroethene) methylene chloride (CH₂Cl₂ aka methylene chloride). Another example of a solvent cleaner includes non-halogenated solvents. Non halogenated solvents include any solvent that does not include a halogen atom. I.e., a solvent that does not include fluorine, chlorine, bromine, iodine, and astatine.

FIG. 2 also shows that the method 200 can include providing a lubricating agent 204. In at least one implementation, the lubricating agent provides the lubrication for a mechanism. In particular, the lubricant is applied to the mechanism. The solvent cleaner completely or partially vaporizes, leaving only the lubricating agent behind to lubricate the mechanism. In general, lubricating agents are quite expensive. Therefore, the solvent cleaner can be used to maximize the efficient application of lubricating agent to the mechanism.

One example of a lubricating agent includes perfluoropolyethers (PFPEs). PFPEs are polyethers in which all of the hydrogen atoms have been replaced with fluorine atoms. A polyether is a hydrocarbon with more than one ether group. The carbon chains connecting the ether groups can be of identical length to one another or can be of different length from one another. An example of an acceptable PFPE is Krytox (made by DuPont). Krytox includes polymers of polyhexafluoropropylene oxide, with a chemical formula:

F—(CF(CF₃)—CF₂—O)ₙ—CF₂CF₃

where the degree of polymerization, n, generally lies within the range of 10 to 60.

In addition to PFPE, Krytox also includes telomers of polytetrafluoroethylene (PTFE). In chemistry, PTFE is a synthetic fluoropolymer of tetrafluoroethylene that finds numerous applications. PTFE is most well-known by the DuPont brand name Teflon. Krytox is thermally stable, nonflammable (even in liquid oxygen), and insoluble in water, acids, bases, and most organic solvents. It is nonvolatile and useful over a broad temperature range of −75 to 350° C. or higher. It can also withstand extreme pressure and high mechanical stress.

Another lubricating agent can include mineral oil, Bees wax, Paraffin oil or wax based lubes. Another lubricating agent can include petroleum sulfonates. A petroleum sulfonate is a salt or ester of a sulfonic acid. I.e., it contains the functional group R—SO₂OH).

In at least one implementation, the ratio of solvent cleaner to lubricating agent can be any desired ratio. In particular, the ratio can include enough solvent cleaner to ensure that the lubricating agent is sufficiently spread to lubricate the desired mechanism without overly diluting the lubricating agent. Additionally or alternatively, the ratio can include enough solvent cleaner to ensure that the debris is sufficiently removed by the solvent cleaner.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

### Examples of a Lubricant Applicator

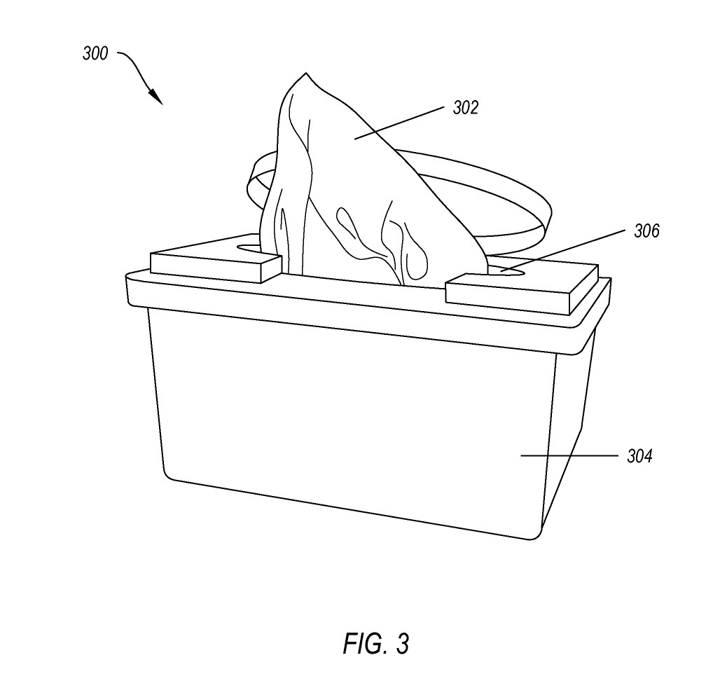

FIG. 3 illustrates an example of a lubricant applicator 300. In at least one implementation, the lubricant applicator 300 makes it easier for a user to apply the lubricant. In particular, the lubricant applicator provides a predetermined amount of lubricant, which the user can then apply to the area needed.

FIG. 3 shows that the lubricant applicator 300 can include a wipe 302. In at least one implementation, the wipe 302 can include a fabric embedded with the lubricant which can be wiped on the mechanism to be lubricated. The wipe 302 can include a disposable wipe. For example, the wipe 302 can include a tissue. Tissue, also called a paper handkerchief, refers to a class of soft, absorbent, disposable papers.

Additionally or alternatively, the wipe 302 can include a fabric. In at least one implementation, the fabric can include any network of natural or artificial fibers including textiles and cloth. In at least one implementation, the fibers can include thread or yarn. For example, yarn can be produced by spinning raw wool fibers, linen, cotton, or other material on a spinning wheel to produce long strands. The fabric can be formed by weaving, knitting, crocheting, knotting, or pressing fibers together, such as in felt. One of skill in the art will appreciate that the fabric can include a single fiber or more than one fibers.

FIG. 3 also shows that the applicator 300 can include a container 304. In at least one implementation, the container 304 is configured to be air tight. In particular, the container 304, when closed, can prevent the exchange of gas with the exterior of the container 304. This can prevent the evaporation of the volatile solvent cleaner. I.e., the container 304 can allow the wipes 302 to be removed when needed for use but preserve the lubricant when not in use.

FIG. 3 further shows that the applicator 300 can include an opening 306. In at least one implementation, the opening 306 can allow a user to retrieve a wipe 302 when desired. In particular, the wipes 302 can be folded onto one another, such that when a first wipe 302 is removed from the container 304 a portion of a second wipe 302 extends from the opening 306, allowing the user to pull out the second wipe 302 when desired.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A lubricant for application on an external device, the lubricant comprising:
a solvent cleaner; and
a lubricating agent.

2. The system of claim 1, wherein the solvent cleaner includes a hydrofluorocarbon.

3. The system of claim 2, wherein the hydrofluorocarbon include Vertrel XF.

4. The system of claim 1, wherein the solvent cleaner includes a perfluorocarbon.

5. The system of claim 4, wherein the perfluorocarbon includes at least one of:
perfluoropentane;
perfluorohexane;
perfluoroheptane;
perfluorooctane;
perfluorohexene; or
perfluoruoctene.

6. The system of claim 1, wherein the solvent cleaner includes a methyl siloxane.

7. The system of claim 1, wherein the solvent cleaner includes a hydrofluoroether.

8. The system of claim 7, wherein the hydrofluoroether includes one of:
HFE-7000;
HFE-7100; or
HFE-7200

9. The system of claim 1, wherein the solvent cleaner includes at least one of:
a super critical fluid;
kerosene;
mineral spirits;
alcohols;
terpenes;
C5-C20 petroleum hydrocarbons;
oxygenated organic solvents
a vanishing oil.

10. The system of claim 1, wherein the solvent cleaner includes at least one of
dichloropentafluoropropane;
heptafluorocyclopentane;
n-Propyl bromide;
a chlorinated hydrocarbon; or
a non-halogenated solvent.

11. A system for applying a lubricant to an external device, the system comprising:
a wipe; and
a lubricant, wherein the lubricant:
is embedded in the wipe; and
includes:
a solvent cleaner; and
a lubricating agent.

12. The system of claim 11, wherein the lubricating agent includes a perfluoropolyether.

13. The system of claim 12, wherein the perfluoropolyether includes telomers of polytetrafluoroethylene.

14. The system of claim 13, wherein the perfluoropolyether includes Krytox.

15. The system of claim 11, wherein the lubricating agent includes at least one of:
mineral oil;
Bees wax;
Paraffin oil;
wax based lubes; or
petroleum sulfonates.

16. A system for applying a lubricant to an external device, the system comprising:
a wipe;
a container, wherein:
the wipe is located within the container;
the container includes an opening, wherein the opening is configured to allow a user to access the wipe if desired; and
the container is configured to prevent air exchange between the interior of the container and the exterior of the container if the opening is closed; and
a lubricant, wherein the lubricant:
is embedded in the wipe; and
includes:
a solvent cleaner, wherein the solvent cleaner vaporizes completely; and
a lubricating agent, wherein the lubricating agent either:
does not vaporize; or
vaporizes at a low rate.

17. The system of claim 16 further comprising a second wipe, wherein:
the second wipe is located within the container; and
the lubricant is embedded in the second wipe.

18. The system of claim 17, wherein the first wipe and the second wipe are folded such that removal of the first wipe from the container removes at least a portion of the second wipe from the container.

19. The system of claim 16, wherein the wipe includes at least one of:
a paper tissue; or
a fabric.

20. The system of claim 16, wherein the external device includes a bike chain.
